(19) United States
(12) Patent Application Publication
(10) Pub. No.: US 2007/0136255 A1
(43) Pub. Date: Jun. 14, 2007

(54) System and method for generating, maintaining, and rendering landing and web pages

(75) Inventors: Joseph Rizzo, Herndon, VA (US); Brian Davis, Harrisonburg, VA (US); Jason Clamp, Elkton, VA (US)

Correspondence Address: ROTHWELL, FIGG, ERNST & MANBECK, P.C., 1425 K STREET, N.W., SUITE 800, WASHINGTON, DC, 20005, US

(73) Assignee: iNeoMarketing, Inc., Herndon, VA (US)

(21) Appl. No.: 11/603,235

(22) Filed: Nov. 22, 2006

Related U.S. Application Data
(60) Provisional application No. 60/739,158, filed on Nov. 25, 2005.

(51) Int. Cl. G06F 17/30

(52) U.S. Cl. 707/3

(57) ABSTRACT

A system and method are provided for generating, maintaining and rendering landing pages. The system may include a user interface configured to allow input of an identification of a plurality of fields and rendering criteria. A template defines a look and feel of a web page. A landing page generating facility is configured to receive an identification of a plurality of fields and rendering criteria from the user interface and to generate a landing page based on the template and the rendering criteria. The landing page includes the plurality of fields.

### CROSS REFERENCE TO RELATED APPLICATIONS

This application claims the benefit of the earlier filing date of, and contains subject matter related to that disclosed in, U.S. Provisional Application Ser. No. 60/739,158, filed Nov. 25, 2005, the entire contents of which are incorporated herein by reference.

### COPYRIGHT NOTIFICATION

Portions of this patent application contain materials that are subject to copyright protection. The copyright owner has no objection to the facsimile reproduction by anyone of the patent document, or the patent disclosure, as it appears in the Patent and Trademark Office, but otherwise reserves all copyright rights.

### BACKGROUND OF THE INVENTION

1. Field of the Invention

The present invention relates, generally, to systems and methods for generating and hosting web pages. More particularly, the present invention relates to systems and methods for generating, maintaining, and rendering a “landing page.”

2. Description of the Related Art

Conducting business over the Internet, or online, often called eCommerce, is well known. Today, nearly every type of conventional business practice or transaction is or can be offered over the Internet, in one form or another. One main advantage with conducting business electronically is that relevant information may be easily shared, stored, etc. without the need to generate and process paper. For example, when making an online purchase, an Internet user can browse online catalogs for products and submit credit card and shipping information (e.g., customer information) via a form that can be filled out online through a web browser. This customer information can be stored by the online vender and reused with future purchases.

Online marketers use something called a “landing page” (sometimes called a “jump page” or “flash page”) for collecting additional consumer information and for implementing certain online marketing schemes. A “landing page” is a world wide web page (e.g., HTML document) that is made to appear temporarily and is typically related to products or services (or other events, business, charitable or private endeavors, or any other subject matter) that are the focus of a promotion, marketing campaign, outbound communication or any other means by which to draw attention thereto. For example, a landing page could be, without limitation, a web page that an Internet user is taken to after completing an online transaction, clicking on an online advertisement, or performing some other operation. For example, an online vendor may offer its customers special deals immediately after an online purchase is made. In such a case, the purchaser may be redirected to a new web page (i.e., a landing page) providing the details about the special offer. In another example, a landing page may be used to collect registration or survey information after a website visit. Landing pages need not be part of the originated website and are often hosted by third parties specializing in various web services.

Landing pages have been found to be extremely useful for collecting valuable information about online consumers and potential customers. Some online vendors design and deploy dozens or even hundreds of landing pages accessible via links on their and others' websites. It is desirable that a landing page appear like (i.e., have the same “look and feel” as) the website, web page or communication from which it was launched, so that the online consumer believes that he or she has not been redirected to an unknown website. Often sales and marketing professionals would like to generate landing pages for a specific event. However, design, creation and maintenance of landing pages require the services of information technology (IT) professionals (e.g., an organizations IT department, database administrators, webmasters, contractors, etc. (“IT professionals”)) and is often time consuming and expensive. Sales and marketing professionals prefer not to, or do not always have time to involve their IT professionals with every request.

Thus, there exists a need for new and improved systems and methods for generating and maintaining landing pages quickly, efficiently, and in a simple manner that can be performed by business persons without the need for involving IT professionals.

### SUMMARY OF THE INVENTION

It is an object of the present invention to overcome disadvantages of the prior art by providing new and improved systems and methods for generating, maintaining, and rendering landing pages “on-the-fly”, in real-time, efficiently, and simply, in a manner that can be performed by business persons without the need for involving IT professionals. Aspects of the present invention are embodied in a web service known as “PluraPage™,” (www.plurapage.com) owned and managed by iNeoMarketing, Inc.

The present invention allows a company/account holder (e.g., “administrator”) to easily create an unlimited number of web pages that can be immediately made available over the Internet. In embodiments of the present invention, landing pages can be generated based visually on one page layouts (e.g., template), which can be custom designed to match the administrator's corporate image or communication objectives. According to embodiments of the present invention, an administrator can specify a unique domain name that can be automatically registered and used with features of the present invention. In one embodiment, one or more web pages can be made accessible through a user-designated subfolder or subdomain (e.g., “www.anydomain.com/folder_name”).

According to an embodiment of the present invention, landing pages can be managed through a user-friendly administration module. Preferably, the content of each landing page is highly customizable with space for additional specified questions. The system may be configured such that data is easily retrieved through the administration module.

According to an embodiment of the present invention, systems and methods are provided for generating, rendering and maintaining landing pages. Data is maintained relating to the creation, maintenance, and rendering of landing pages, the owners of the landing pages (e.g., administrators), and the use of the landing page including submission data and web analytics.

According to embodiments of the present invention, a process is provided for developing and processing multiple network-based landing pages for access over the Internet using a number of types of functional components or objects. The process can include custom design of a template through which each page is dynamically displayed. The template can include HTML, images, layout cells, colors, and styles for fonts, etc. Template design can be completed from scratch with supplied logos and content. Alternatively, template design can be taken from an existing web page. For example, an existing website can be matched so that end users (e.g., Internet users, consumers) transitioning between the existing, originating website and a landing page will not recognize any difference between the two.

According to embodiments of the present invention, a landing page generated and hosted according to the present invention is configured to receive information via form fields included therein (e.g., contact information, survey questions, etc.), validate the form entries, and after the form is submitted and validated, generate a “Thank You” page, which can use the same layout as the landing page but with different headline and body text, and/or the delivery of various content and data files (e.g. a PDF white paper file). Further, the landing page can generate a customized email thanking the consumer for filling in and submitting the information form, with any other information specified. The information submitted via the landing page may be instantly emailed (e.g., in a flat file attachment) to the landing page owner (e.g., administrator) for additional follow up, or exported periodically through an administration module.

Pages can be easily edited through the administration module by selecting the page name and making the appropriate changes. If additional, but similar pages are required (e.g. a page with similar text but a different downloadable file), a duplicate can be generated with one click. All pages, files, and links can be easily removed once no longer needed.

According to embodiments of the present invention, each landing page contains and allows an end user to create, among other things and not limited to: Title; introductory body paragraph; upload of a custom graphic in the body; a standard contact information form containing, among other things and not limited to: Name, Company, Position, Street address, City, State, Zip, Phone, Fax, Email; desired contact fields can be shown or hidden through the administrator; additional questions in the form of, among other things and not limited to: Short answer, Long answer, Multiple choice (single or multiple selection); radio group, drop down; and a following Thank You page with customizable, among other things and not limited to: Title, Body, Continuing links.

According to embodiments of the present invention, systems and methods are provided for generating, maintaining and rendering landing pages. The systems and methods are preferably web enabled and substantially automated. According to some embodiments, a web-enabled front-end is established which allows administrators to design and generate landing pages, which are immediately available over the Internet. Accordingly, the front-end is configured to allow selection of a template to provide the “look and feel” of the landing page, to select the specific content to be displayed therein as well as any form fields for receiving information (e.g., consumer information), and to configure rendering of the landing page to, upon submission, generate emails, insert or update data to a database, generate and distribute data files (e.g., CSV files), render a post-submission HTML page (e.g., a “Thank You” page), and/or other online features (e.g., redirect, provide links, provide data files, etc.). An HTML document is generated according to the selections and rendering criteria stored. Further, a unique URL can be registered and assigned to the generated HTML document. The HTML document is listed and rendered according to the rendering criteria.

The front-end may be used to access and edit rendering criteria for already designed pages.

Further applications and advantages of various aspects and embodiments of the present invention are discussed below with reference to the drawing figures.

### BRIEF DESCRIPTION OF THE DRAWINGS

FIG. 1 is a block diagram of a system for generating, rendering, and maintaining landing pages according to an embodiment of the present invention.

FIG. 2 is an exemplary object relationship diagram of a system for generating, rendering, and maintaining landing pages according to an embodiment of the present invention.

FIG. 3 is an exemplary connection diagram of a system for generating, rendering, and maintaining landing pages according to an embodiment of the present invention.

FIG. 4 is a flow chart of an exemplary process flow for a method of generating landing pages according to an embodiment of the present invention.

FIG. 5 is a flow chart of an exemplary process flow for a method of rendering landing pages according to an embodiment of the present invention.

FIG. 6 is a dataflow diagram according to an embodiment of the present invention.

FIG. 7 is a flow chart of a method for generating, rendering, and maintaining landing pages according to an embodiment of the present invention.

FIG. 8 is a flow diagram of data transfer methods according to an embodiment of the present invention.

FIGS. 9a-9h are screen shots of an exemplary user interface of a system for generating, rendering, and maintaining landing pages according to an embodiment of the present invention.

FIGS. 10a-10g are screen shots of an exemplary user interface of a system for generating, rendering, and maintaining landing pages according to an embodiment of the present invention.

FIG. 11 is a screen shot of a generated landing page according to an embodiment of the present invention.

FIG. 12 is a screen shot of a generated email according to an embodiment of the present invention.

FIG. 13 is a screen shot of a thank you page generated after submission of a landing page according to an embodiment of the present invention.

FIG. 14 is a network diagram illustrating rendering, submission and post submission processing of a landing page according to an embodiment of the present invention.

FIG. 15 is a schematic diagram illustrating rendering, submission and post submission processing of a landing page according to an embodiment of the present invention.

FIG. 16 is a block diagram illustrating creation of a PURL according to an embodiment of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to the embodiments described and/or illustrated herein.

Throughout the body of this document, while describing embodiments of the present invention, references are made to various individuals that can access certain features of the present invention. As used herein, “admin” or “administrator” refers to the entity or person (e.g., company/account owner) that is using the present invention to create and maintain landing pages; “super administrator” or “superadmin” refers to the entity that hosts and maintains the system for generating, maintaining and rendering landing pages; and “user” refers to the end-user (e.g., the consumer or Internet user or visitor) that accesses landing pages as part of an administrator's website, and submits information via the landing page.

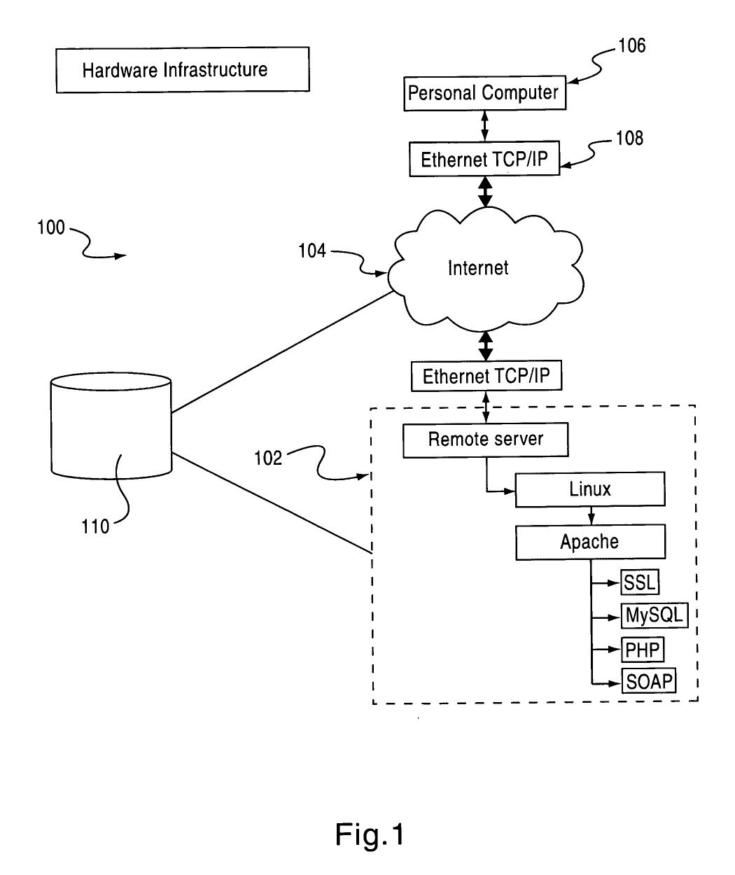

Referring to FIG. 1, a block diagram of a system for generating, rendering, and/or maintaining one or more landing pages is shown. System 100 includes a web server 102 that is coupled with an electronic data network 104 (e.g., the Internet) and is configured to communicate with one or more client user computers 106 via electronic network 104. Web server 102 and client computers 106 may be coupled with the electronic data network via a TCP/IP connection 108 via, for example, via an Internet Service Provider (ISP).

The client user interface 106 can be configured to access web pages via the electronic data network 104. Accordingly, the client user interface 106 would typically include a personal computer or any other device capable of executing a web browser. Internet access can be made through conventional arrangements, such as via a TCP/IP connection, via an ISP or other suitable connection.

Web server 102 is configured to generate, maintain, and host web pages (e.g., HTML documents), including provision of services associated with the rendering of dynamic web pages, such as data storage services, security services, etc. Accordingly, server 102 can include a conventional hardware arrangement and be outfitted with software and/or firmware for performing web server functions for performing aspects of the present invention, such as, for example, LINUX operating system, APACHE web server software, and facilities for SSL, MySQL, PHP, and SOAP, etc.

Web server 102 may be coupled with a data storage facility 110, for maintaining data, files, graphics, etc. related to generation and rendering of web pages. Data storage facility 110 may include one or more local or remote memory units, and can include one or more databases and/or file systems for storing data, graphics, HTML documents, XML documents, etc. As will be explained in further detail below, web server 102 may host a user interface configured to allow users to design landing pages for generation and rendering, including generation and registration of a URL for each landing page, as well as being configured to host the landing pages themselves.

According to embodiments of the present invention, a user interface may be configured to allow an administrator to select a template to provide the “look and feel” of the landing page, to select the specific content to be displayed therein as well as any form fields for receiving information (e.g., consumer information). Further, the landing page can include (or be rendered with) features that, upon submission, generate emails, insert or update data to a database, generate and distribute data files (e.g., CSV files), render a post-submission HTML page (e.g., a “Thank You” page), and/or other online features (e.g., redirect, provide links, etc.). Preferably, a single template is used by an administrator to generate a plurality of landing pages having a same look and feel. The user interface may be configured to allow an administrator to modify design of existing landing pages as well.

According to one aspect of the present invention, personalized landing pages (PURLs) can be dynamically generated based on data provided (pushed) to or pulled-down by the system. Data may be extracted from a remote source, such as a customer relations management (CRM) system, a sales and marketing database, or the like. Alternatively, information specific to the generation of PURLs may be provided by the user via an interface or a flat file. Web server 102 preferably includes a PURL engine for generating PURLs “on-the-fly,” in real-time.

As referenced herein, the term PURL is used to refer not only to the personal URL itself, but also to an HTML document or web page associated therewith, which includes personalized information. In essence, a PURL is a personalized, unique landing page generated by merging personalized data with a landing page generated by the present invention. The PURL engine is configured to generate a PURL based on the same templates that are used to generate landing pages, except that personalized data can be included in the form fields. For example, a pre-filled form can be created for a particular consumer or contact from within a CRM. PURLs are preferably editable so that the recipient of the PURL can correct any inaccurate information or add new information. The PURL engine is also configured to generate and register a unique URL to be assigned to the personalized landing page. One way for generating URLs is to concatenate a folder name, which may be chosen by the administrator, to an existing, registered URL (e.g., www.anydomain.com/first_name last_name). In this way, a personalized link may be created for a personalized landing page.

According to an embodiment of the present invention, page headlines and body text can be specified through simple plain-text (or HTML) entry in an administration form. Styles and formatting can be defined by the template. Extra images can also be uploaded for display on the page. Preferably, the end user can specify an email that is sent to the user after completing the form. The subject, body and From address of the email can be pre-specified, or the administrator may choose not to send a notification email at all. Data that is entered by the end user can be emailed in a format desired by the administrator, such as, but not limited to, comma separated variable (CSV) format, every time an entry occurs, it can be delivered to any third party data base driven application, or can simply be stored in data storage facility 110.

Text for a Thank You page can also be pre-designated. Any files such as, but not limited to, PDF®s, Word® documents and/or Powerpoint® slideshows can be uploaded to be made available for download through the Thank You page. Links to any other site on the Internet can also be entered to allow the user to continue browsing for additional information.

Accordingly, a user interface can be provided in the form of a GUI or the like, preferably web-enabled, which allows an administrator to enter information for generation, maintenance, and rendering of landing pages without involvement of an IT professional. The user interface can include, for example, a number or HTML documents and can be accessible via the electronic data network 102. Each HTML document can include form fields or the like for selection, insertion, and revision of criteria and data used in the processes of the present invention. An HTML generator may be used to generate the landing pages based upon the criteria and data entered into the interface along with a template that defines the look and feel of the landing page. Landing pages may be generated ahead of time or dynamically, on-the-fly, as the pages are requested.

The system and method of the present invention may be implemented via a web service (e.g., an application service provider (ASP) or the like) and payment may be accepted for the generation and hosting of landing pages on any number of known arrangements (e.g., subscriptions, per-screen, or per-click ). For an example of such a web site, see www.plurapage.com.

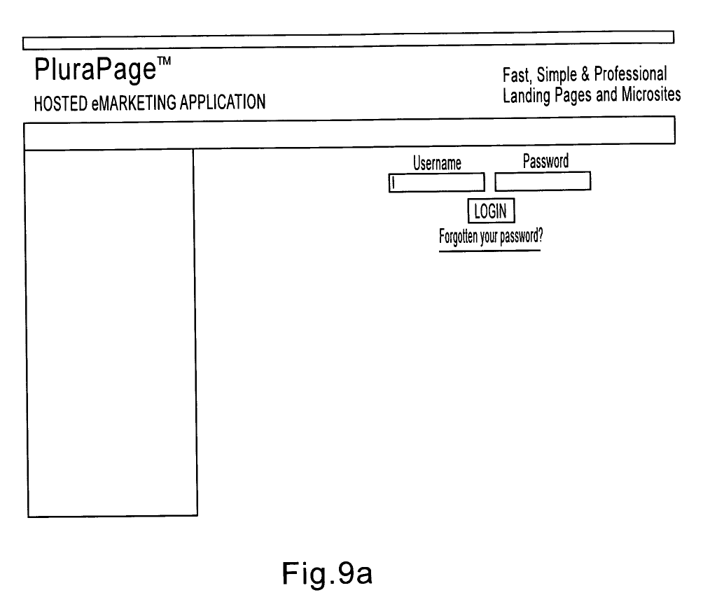

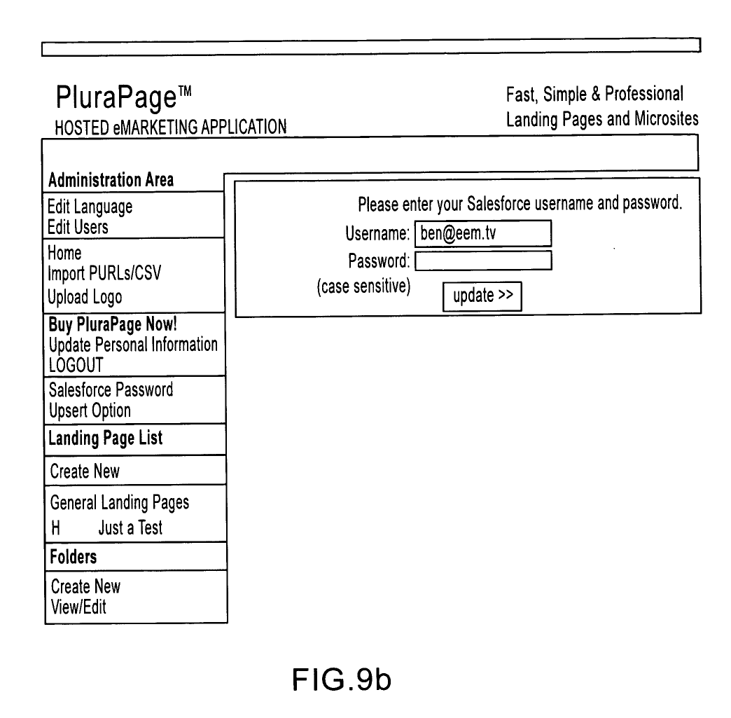

The user interface is preferably rendered with typical features that would be expected with a web service, such as user authentication, security, credit card payment facilities, etc. Screen shots of an exemplary user interface are shown in FIGS. 9a-10g. Each of FIGS. 9a-10g include self-evident features but are also described in further detail below.

According to some embodiments of the present invention, a modular system is provided for developing and processing multiple web-based landing pages for access over the Internet using a number of types of functional components or objects. Components of the system may include data management objects which access and move data within the system as part of the creation and administration of these landing pages and the data gathered therefrom, functional objects that can be used to transform or process the data, presentation objects which provide an interface to the administrator in order to facilitate the transfer of information and control objects which determine when and how the data objects, functional objects and presentation objects should be applied to the data as part of the landing page creation and administration efforts. The system can utilize a standardized, extensible data structure for transferring the data between components or objects which allows the objects to be used as interchangeable building blocks of a comprehensive, flexible system architecture.

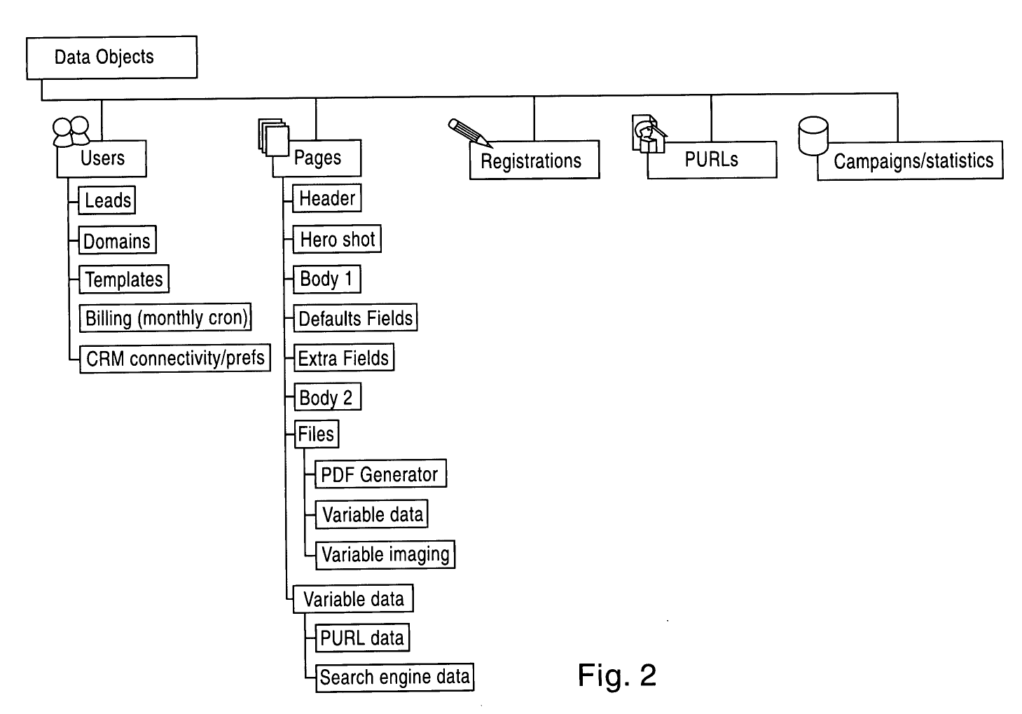

Accordingly, FIG. 2 is an exemplary object diagram that illustrates a data object structure for implementing aspects of the present invention. As shown, the system may maintain user data, page data about the landing pages generated, registration or submission data, data relating to PURLs, and statistical data about use of landing pages. Data may be stored in a variety of known formats but is preferably stored in a relational database (RDBMS). As shown, user data may include sales or marketing information (e.g., “leads”), domain information, template information, billing information and CRM system information.

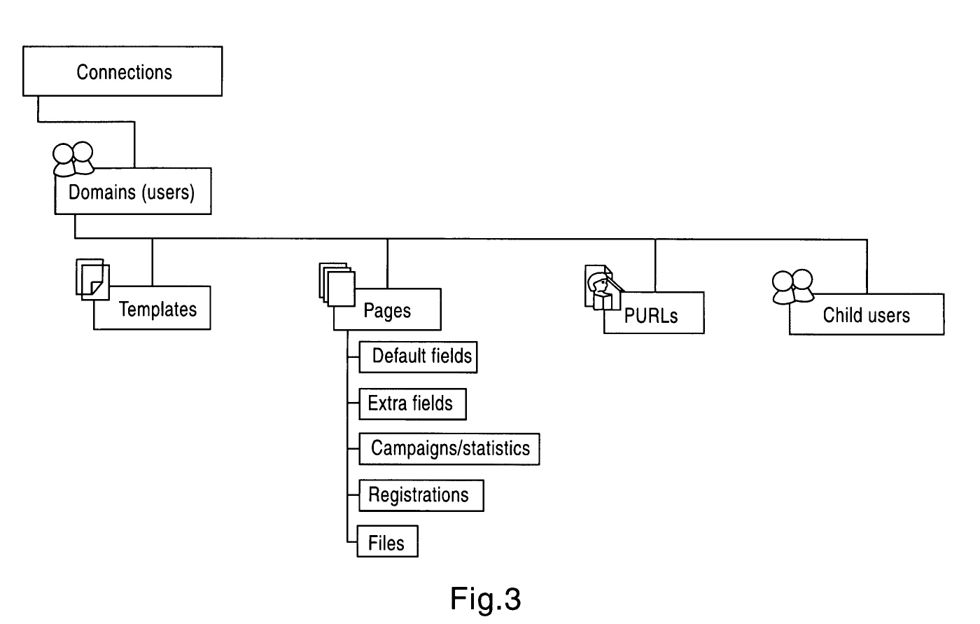

FIG. 3 is a connectivity diagram illustrating basic connections between administrator (domains) and objects throughout a system of the present invention. As shown, each administrator can connect to templates, landing pages, PURLs, and child users.

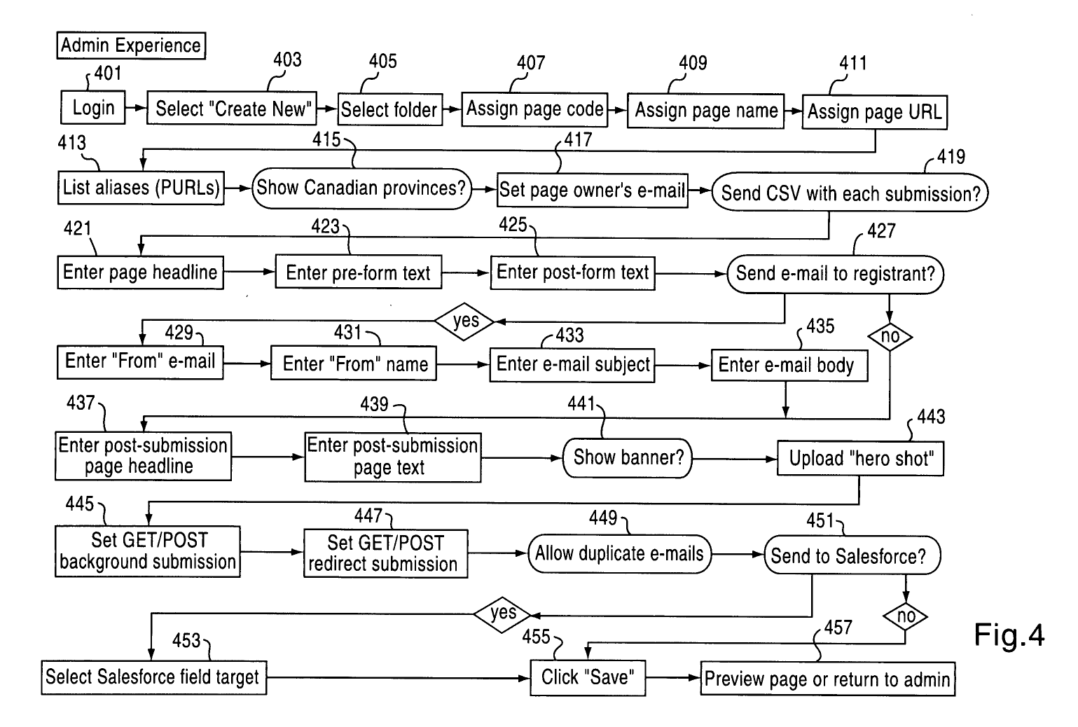

FIG. 4 is a flow chart of a method for generating a landing page according to an embodiment of the present invention. First, at step 401, an administrator logs into the system for generating a landing page via a user interface, such as that shown in FIGS. 9a-10g. Conventional log in procedures can be employed. The administrator selects “create new” (403) to generate a new landing page. Forms are then provided for entry of information used for generating and for rendering the landing page including, but not limited to: folder name (405), page code (407), page name (409), URL (411), aliases for PURLs (413), whether or not any other countries should be included in the addresses, such as Canadian provinces (415), entry for email to be generated upon submission of the landing page (417), whether or not to send a CSV file (419), page headline (421), pre-form text (423), post-form text (425), whether to send an email to the user filling out the form (427), from email address (429), name (431), subject (433), email body (435), post-submission headline (437), post-submission text (439), banner (441), upload a “hero shot”-graphic (e.g. a JPEG image) (443), set the GET/POST (445), GET/POST redirect (447), whether to allow duplicate emails (449), and whether data can be sent to a remote CRM system, such as to SALESFORCE.COM (451). If a CRM system is going to be used, the field targets can be selected at step 453. The information can be saved at step 455, upon which a preview page can be generated thereon or the system can return to an administration page.

Form fields can be standardized or customized. For example, referring to FIG. 9e, such form fields may include first name, last name, job title, company, address, city and state and zip and phone number and email. Of course, other standardized fields may be generated and included. Once this form is submitted, a second form may be rendered which allows the user to customize the landing page form by adding other fields (see, FIG. 9f). An HTML generator can be used to create the landing page based on the information submitted, and based on a selected template. Further, some or all of the information can be stored and used during the rendering process. Each landing page may be generated ahead of time, but in a preferred embodiment, the landing page is generated on-the-fly using a service side scripting platform such as, but not limited to, PHP, JAVA Server Pages (JSP), or ASP.Net.

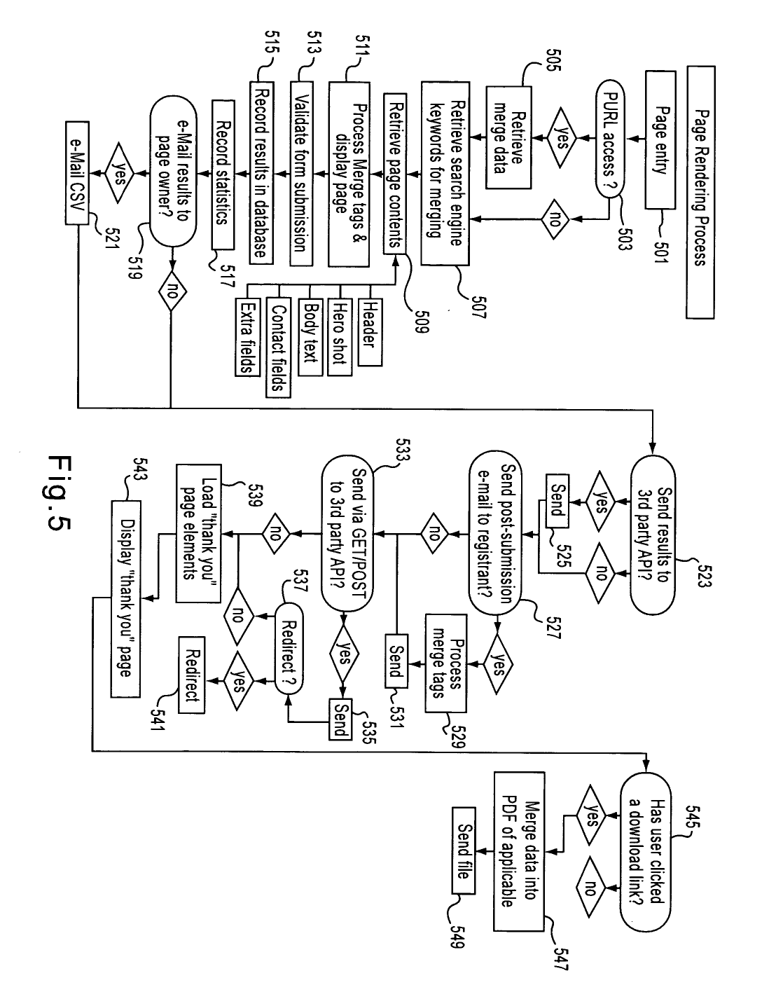

FIG. 5 is a flow chart of an exemplary process for rendering a landing page created according to embodiments of the present invention. One or more of the following steps can be performed via a netscripting language. At step 501, a landing page is selected by any number of methods (e.g., clicking on a link, a redirect process, HTTP request, etc.) via a client user interface. Optionally, when the landing page is requested, the web server rendering the landing page could determine whether a PURL exists for the requester of the landing page (503). Such a check could be made based on the HTTP request for the landing page. If a PURL exists for the user, the PURL can be dynamically rendered instead of the base landing page requested. A PURL is generated by retrieving merge data from memory (503), which may include data from, among other data bases, a CRM system, and by merging the merge data with the landing page to pre-populate one or more of the form fields. The landing page is rendered by steps 507-511.

Then, in step 513, the form fields of the landing page can be filled-out or selected (e.g., check box, dropdown list, etc.). Once the user fills out the fields and submits the form (e.g., by clicking on a submit button), the landing page can be configured to validate the form. If validation fails, an error can be displayed alerting the user to any corrections necessary. Once a submission is validated, the form information can be recorded to memory (515). For example, a database can be accessed and data can be inserted or updated as necessary. Further, statistics related to the use of the landing page can be recorded at this time as well (517).

If so configured, the landing page can generate an email to the landing page owner (e.g., administrator) informing of the results or the existence of the results (519, 521). A flat file could be attached to the email with containing the results. In a preferred embodiment, a CSV file is generated, which can be directly imported into common tools, such as EXCEL.

At step 523, the submission data may also be entered into a third party tool, such as a CRM system. One exemplary CRM system is provided by SALESFORCE.COM. Accordingly, an API can be used to update data in a third party system via the GET/POST function in HTML.

In one embodiment of the present invention, when an email address is submitted by an end user via the landing page, an email is generated to the submitted email address confirming submission of the form (527-531).

Other post submit functions can be performed, such as a redirect (e.g., back to the originating web site) or a post submission page can be rendered, such as a “Thank You” page (539, 543). The post submission page can be set up by the landing page owner during the process of generating the landing page in the administration area and can include various hyperlinks. In one embodiment, a PDF document can be generated and downloaded containing the submitted information (547, 549).

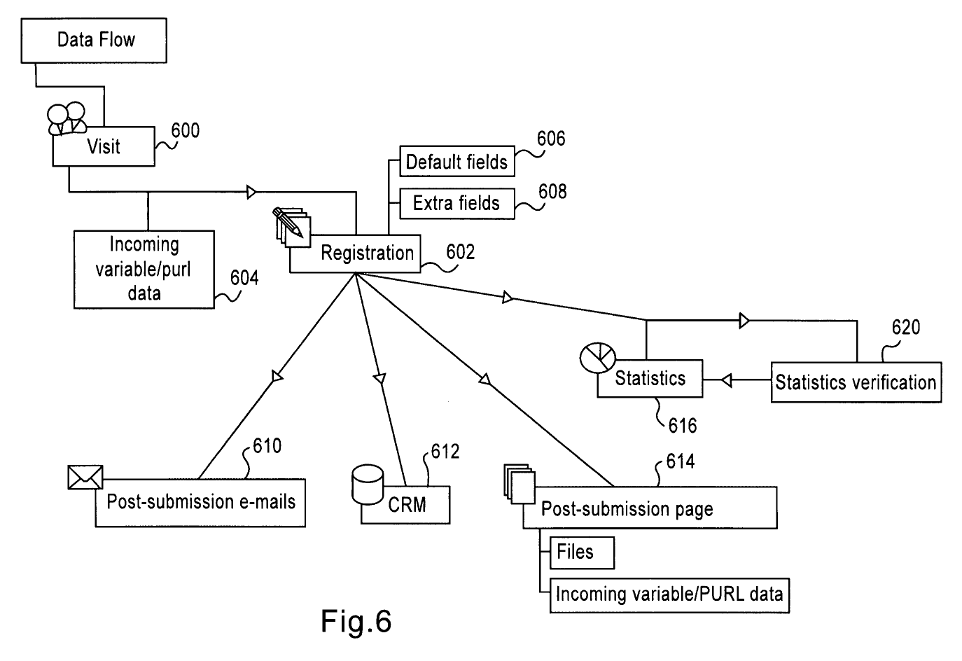

FIG. 6 is a flow diagram showing the flow of submission data from a landing page according to an embodiment of the present invention. As shown, an individual consumer (user) visits the landing page and enters information, which may include preloaded PURL data (604), default fields (606) and extra fields (608). Upon submission of the landing page (registration 602), data can be generated based on the submission and distributed by email (610), electronically to a database (612) (e.g., via an API or driver), in a post submission HTML page (614), and distributed to a statistics module (616) or system that records web analytic type data. The statistics can be validated by a statistics validation module or system 620.

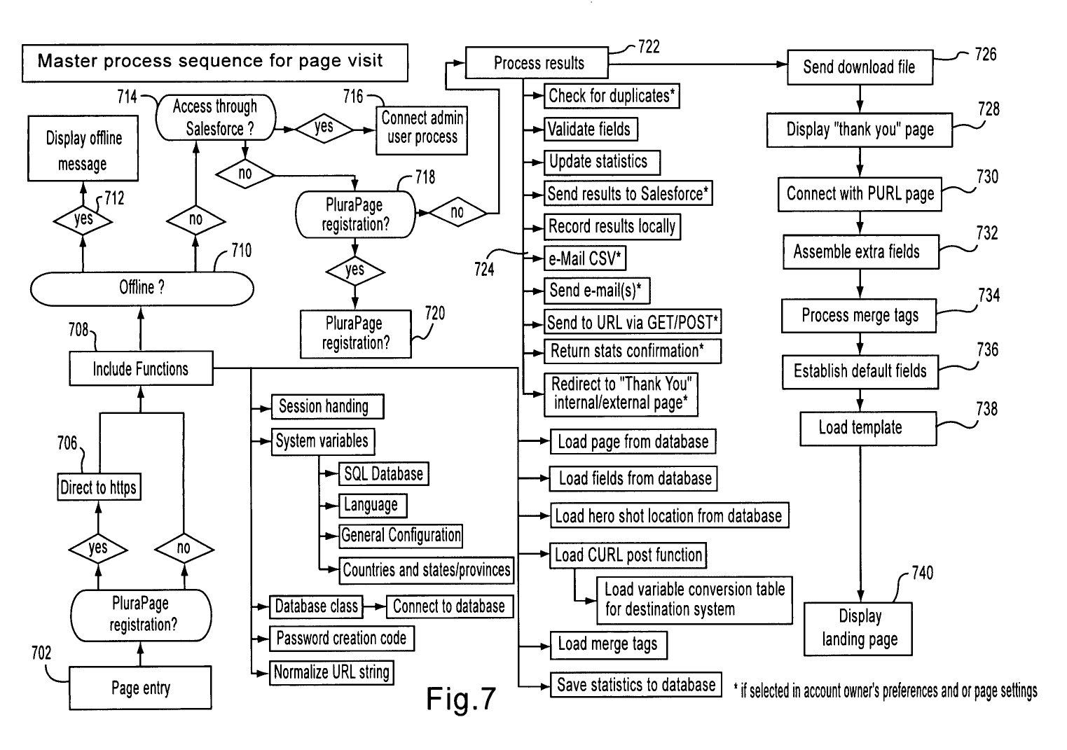

FIG. 7 illustrates a comprehensive process flow for page rendering of a landing page according to an embodiment of the present invention. One skilled in the art will understand that the process flow of FIG. 7 illustrates the logical processes that occur during the rendering process at the web server. As mentioned above, steps of the rendering process can be performed programmatically with the use of an appropriate scripting language.

First, a user visits a landing page generated and hosted by a web service such as the PLURAPAGE™ service. A user accesses the landing page by requesting a URL via a web browser or by clicking on a link (702). Based on the request, the web server hosting the URL performs a number of processes before loading the page. Further, the web server performs these same processes upon submission.

First, a decision is made whether to use SSL (704), if the landing page requested includes a credit card payment facility or otherwise requires a secure connection (706). This determination can be made from the URL or from the HTML of the landing page requested.

Next, the web server loads all the necessary functions for the landing paging (708), including, but not limited to, facilities for session handling, system variables including database connection, language, general configuration information, and form information (e.g., country and state information), class information, database class information, password creation code, normalize URL string, load page from database, load fields from database, load “hero shot location,” load CURL post function, load merge tags, and save statistics to database.

If an administrator has turned OFF a landing page or assigned it an inactive status, an offline message is displayed (712) and processing ends. Otherwise, it is determined whether the landing page was requested from a CRM system, such as from SALESFORCE.COM (714). In this case, the landing page may be used to access administrative screens and a process is initiated for connecting to the administrative portions of the system (716), and the process ends.

If not from a CRM system, a determination can be made based on the URL, whether the landing page requested is a PLURAPAGE™ (718) page and if so, a registration process is begun (720). If not, then it is determined that a landing page has been requested and processing of the landing page is complete (722). Next, it is checked to see whether the request is a first request for the page or whether a page has been submitted. If it is a submission, then submission processing is performed (724) including processing related to, but not limited to, field validation, updating statistics, sending results to a CRM system, recording results locally, sending emails, sending URL to GET/POST, return statistics confirmation, and redirect to a thank you page.

Otherwise, the landing page is rendered. During rendering of the landing page, it is determined whether to download a file (726), display a thank you page (728), to include a PURL (i.e., pre-populate form fields) (730), and assemble any extra fields (732). As required, data is merged with the HTML in the case of a PURL (734), and default fields are loaded as well as the template (736, 738) in order to render the webpage to the requestor (740).

The rendering process is preferably performed using a PHP script which accesses rendering parameters stored locally, but is not limited to any particular kind of programming or software.

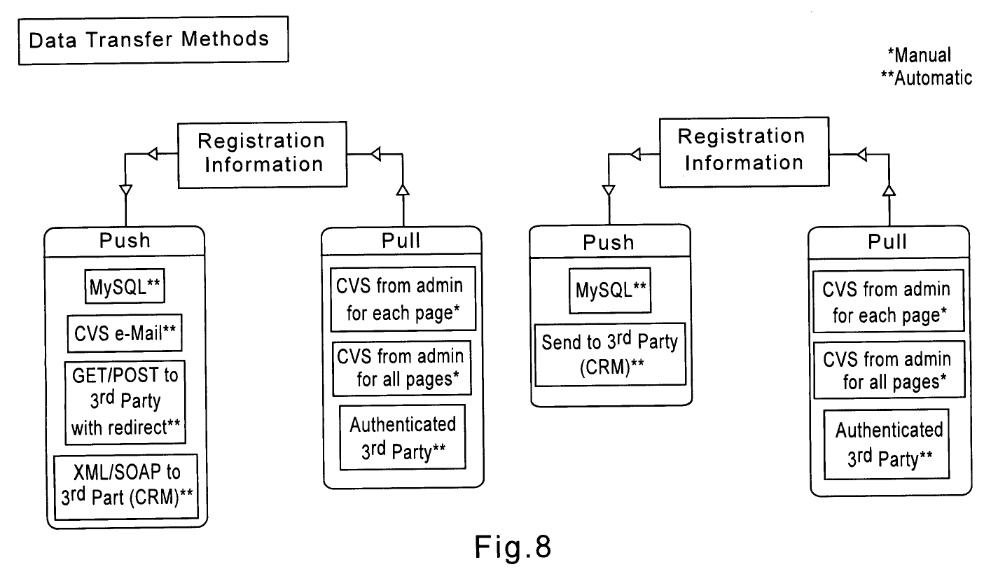

FIG. 8 is a flow diagram illustrating data transfer methods according to embodiments of the present invention. As shown, submission data can be pulled from CSV files and pushed to a database via MySQL, to recipients via email, to third party systems via GET/POST or XML/SOAP.

FIGS. 9a-10g are screen shots of exemplary pages of the system and method of the present invention, which form a web-enabled, GUI interface for administrators and super-administrators who want to access and use certain aspects of the present invention. The particular look and feel of these screens is exemplary in nature and is not intended to limit the present invention.

A menu is positioned vertically along the left side of each screen. The menu may change based on the screen selected and based on the user of the system. For example, a super-administrator may have different options than an administrator; further, among administrators, different features could be provided based on subscription levels, for example. Selection of a menu option shall launch one or more administrative screens.

The information submitted through the user interface shown in FIGS. 9a-10g is stored in a database and is used for the generation of or rendering of landing pages. One skilled in the art will understand that many techniques exist for generating and rendering HTML documents. One skilled in the art will understand that the data, files, graphics, etc. submitted can be stored and revised, and later used to select and control rendering facilities at the web server during rendering of the landing page, dynamically, on-the-fly, in accordance with the present invention.

FIG. 9a is a screen shot of a standard login screen that can accept a user ID and password for initiation of losing processing. FIG. 9b is a screen shot of a screen allowing entry of a CRM, user ID and password, such as for SALESFORCE.COM which can be used to access data in the CRM database when generating PURLs, processing submission data, etc. FIG. 9c is a “welcome page” including startup guide information.

FIGS. 9d-9h are screen shots of exemplary forms for entry of specific information used to design, generate, and render a landing page, including PURLs. FIG. 9d includes a number fields including Folder, Page Code, Page Name, URL Folder, Canadian (i.e., foreign provinces), Email to address, send CSV checkbox, Page Headline, Body 1 (text or HTML), Body 2 (text or HTML), Email registrant checkbox, email “from name,” email “from account,” email subject, email body, Thank You page headline, Thank You page text, show banner checkbox, pictures to load, send data to address, redirect data and registrant to address, no duplicates checkbox, and a SALESFORCE.COM checkbox. The Save button allows submission of this form and saves the submission to memory.

FIG. 9e is a screen shot of a form for selecting standardized fields to include on the landing page. Any number of standardized fields could be included on this form. Checked boxes can be used to include or exclude various fields.

FIG. 9f is a screen shot of a form for adding addition form questions. This screen shot is self explanatory. FIG. 9g allows files or links to be uploaded and displayed in a post submission screen. FIG. 9h allows the addition of a link to be used to redirect the user upon submission of the landing page.

Each of the screens when submitted result in capture (or update) of generation and rendering parameters (together referenced as rendering parameters), which can be stored in memory.

FIGS. 10a-10g relate to administrative options for the maintenance of landing pages generated according to an embodiment of the present invention.

FIG. 10a is a screen shot of a screen that provides a consolidated campaign report, which performs audit functions and allows a flat file to be generated upon the click of the “generate CSV” button 1002. The underlying data relates to statistics collected relating to the landing pages generated, their submission rates and efficacy.

FIG. 10b is a screen shot of a screen that allows the creation of PURL's based upon imported data in the form of a CSV file or other data source. The screen allows selection of the delimiter and/or enclosures for data.

FIG. 10c is a screen shot of a screen that allows uploading of a logo for use with generation of a landing page.

FIG. 10d is a screen shot of a screen that allows an administrator to update their personal information including payment information.

FIG. 10e is a screen shot of a screen that allows administration of something called the “upsert option,” which is an option currently specific to SALESFORCE.COM users. UPSERT is believed to be a trademarked term owned by SALESFORCE.COM. Upsert allows submission data to be inserted into a SALESFORCE.COM database or used to update the data already contained therein. When data is new, it is inserted into the SALESFORCE.COM database as new data, but when existing data in the SALESFORCE.COM data base is different from that data originating from the existing embodiment of the present invention, the data in the SALESFORCE.COM database is updated accordingly. Selection of the UPSERT option shall result in a submission to SALESFORCE.COM to turn the option on. For more information on UPSERT, see www.salesforce.com.

FIG. 10g is a screen shot of a folder maintenance screen. Existing folders are listed for the administrator. By clicking on the “Create a new folder” link, FIG. 10g is launched which allows creation of a new folder. Folders can be used to organize landing pages and for creating unique URL's for PURL'S.

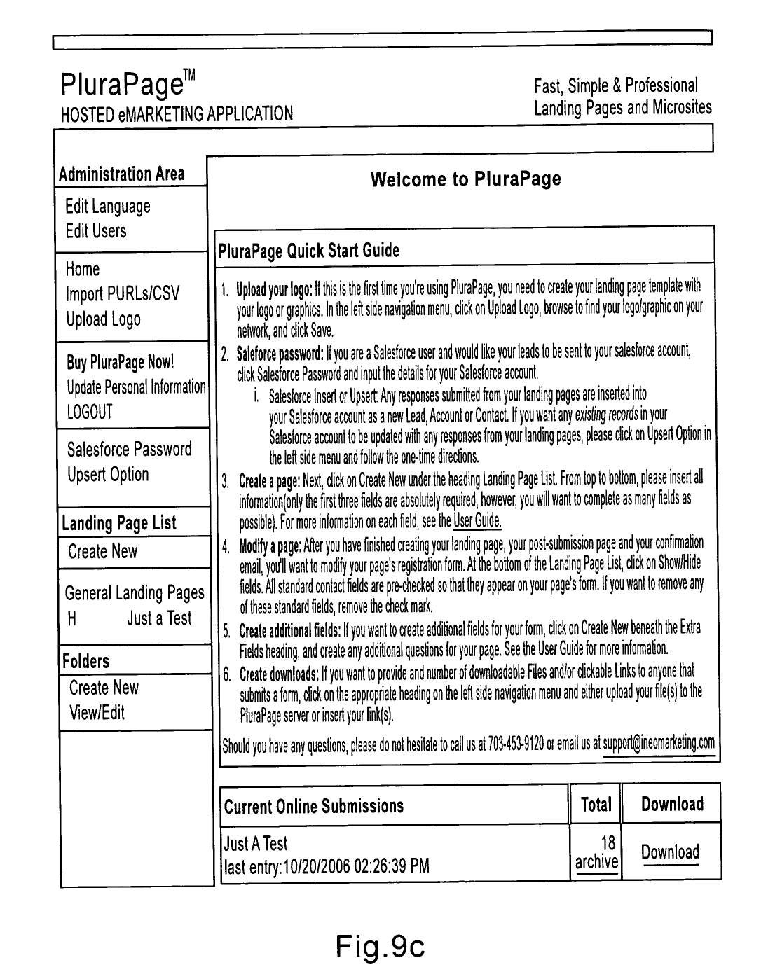

FIG. 11 is a screen shot of a basic, exemplary landing page generated in accordance with an embodiment of the present invention. The form contains a header 1102, embedded graphics 1104, body text 1106, an embedded link 1108, more body text 1110, and a form 1112 including form fields for submission. This particular screen 1100 does not include pre-populated fields. However, if a PURL existed for this HTML document, data from a database could have been merged with the form fields 1112 at the time of rendering.

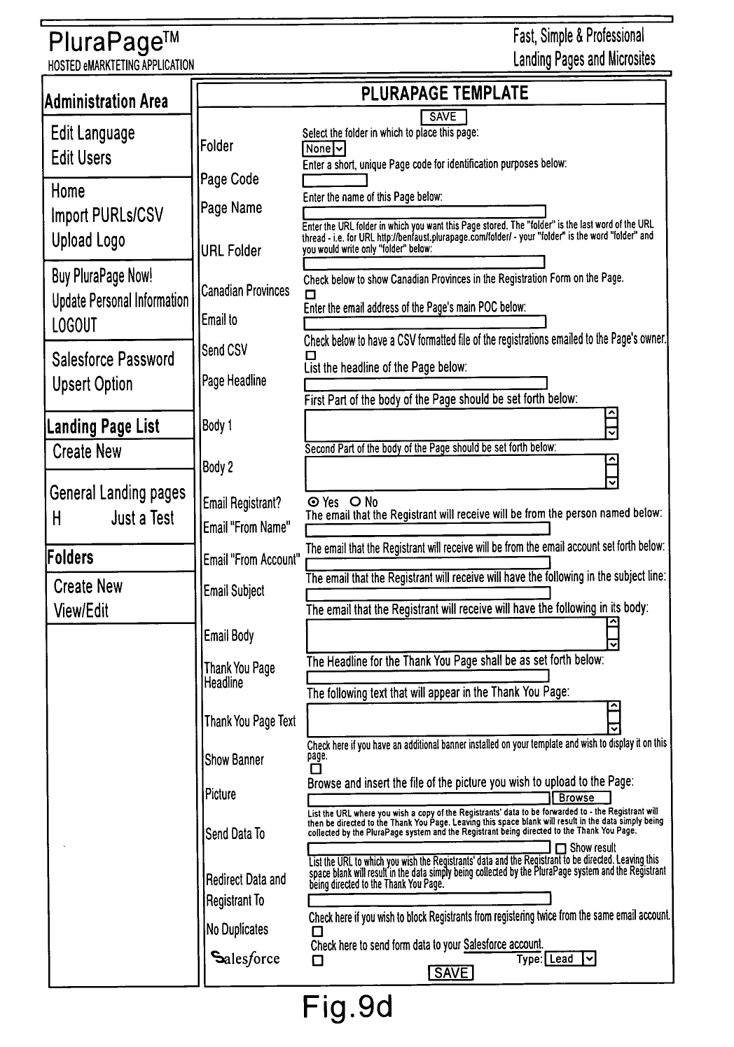

FIG. 12 is a screen shot of an exemplary email generated to an administrator upon activation of a PLURAPAGE account. This email is an example of an email that can be generated upon the submission of any landing page according to an embodiment of the present invention. As described above, the contents of the email can be preselected and stored. The email is generated on-the-fly based on the submission data and the stored email parameters. Generation of the email can be performed with known scripting languages such as PHP, etc.

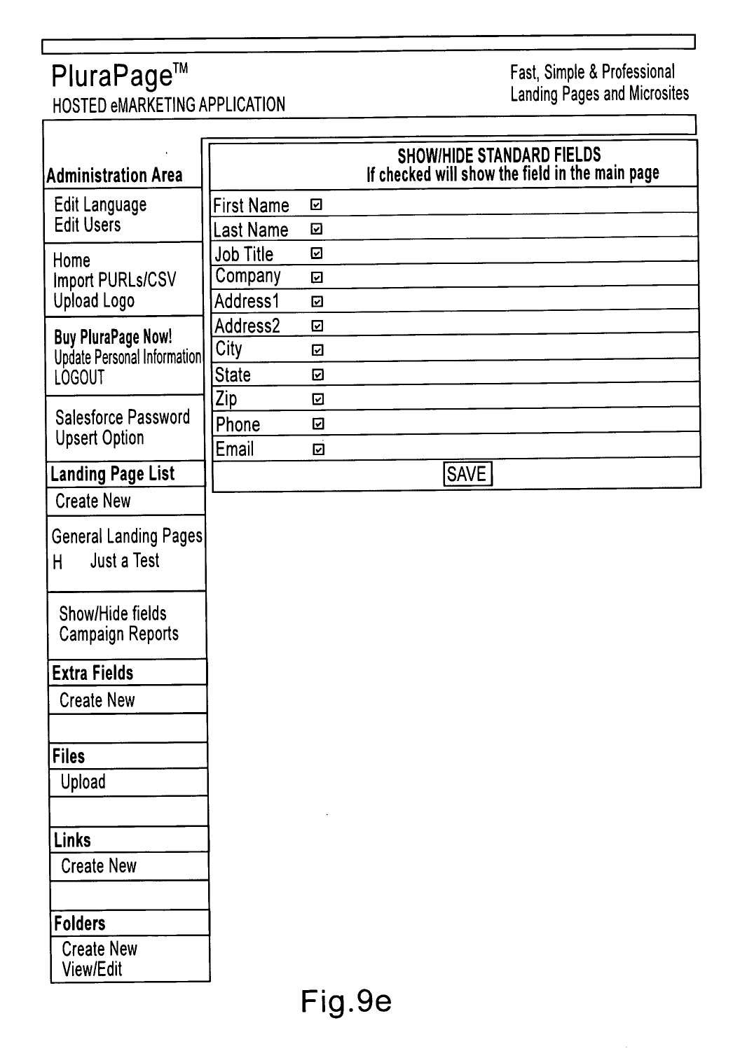

FIG. 13 is an exemplary post submission or Thank You screen that can be generated upon the submission of any landing page according to an embodiment of the present invention. In this case, the screen is generated upon the submission of any landing page according to an embodiment of the present invention. As described above, the contents of the Thank You page can be preselected and stored. The Thank You page can then be generated on-the-fly based upon the submission data and the stored parameters, via a script, such as a PHP script.

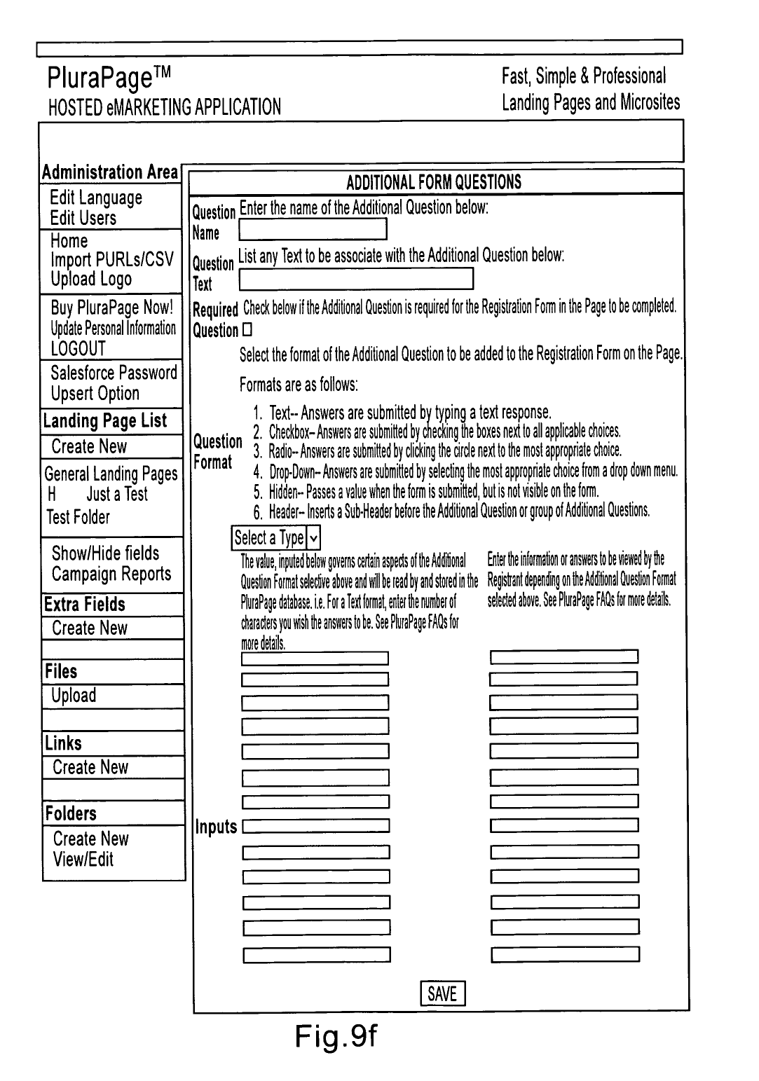

FIG. 14 is network diagram illustrating rendering, submission and post submission processing of a landing page according to an embodiment of the present invention. Referring to FIG. 14, in step 1, the landing page is rendered as already described above. As shown, the domain is analyzed the template is retrieved from the file system. Next, the folder (subdomain) is analyzed and corresponding page contents are retrieved. The page is according rendered. In step 2, the page is submitted by the end user and the results are passed to MySQL for storage. In step 3, post submission processing includes generation of an email, REST Web Service, SOAP Web Service and a CSV via an email, as already described above.

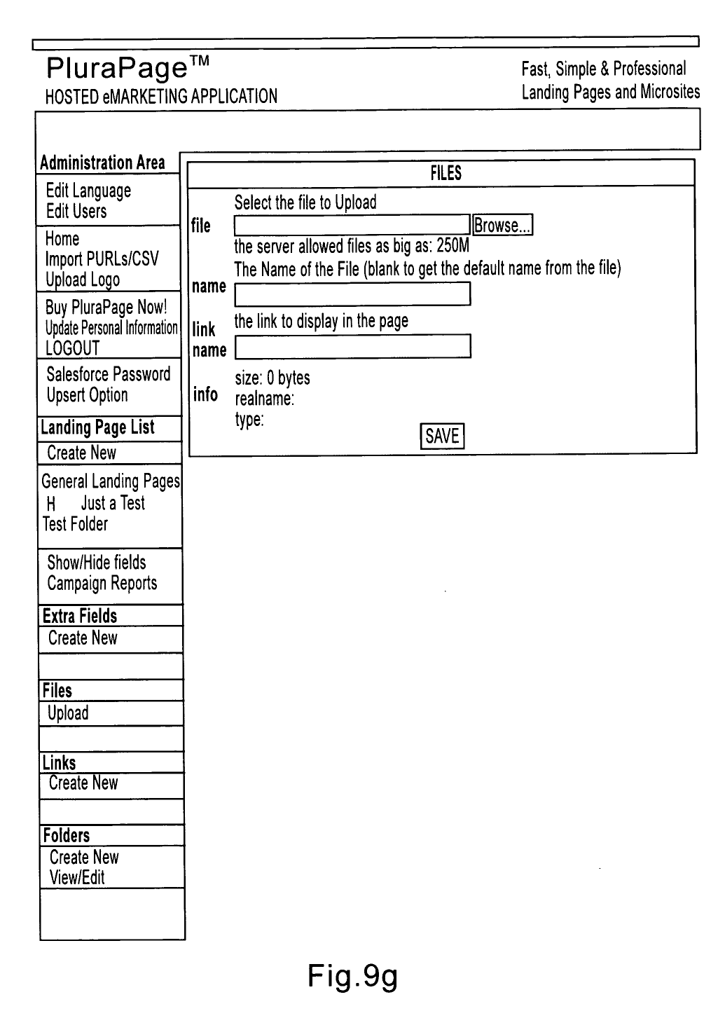

FIG. 15 is a schematic diagram illustrating processing of a landing page according to an embodiment of the present invention. Server layer includes server specifications, web server facilities (e.g., APACHE), and scripting (e.g., PHP), etc., which render a webpage 1500. Upon submission of a landing page, submission data is transmitted via an email 1502 (e.g., to the end user), to a third party via a Post-Submit page 1504, GET/POST REST system 1506, or SOAP System XML webservice 1508, in a CSV file to an administrator via email 1510, and is stored into data storage facilities that are part of the system, via, for example, MySQL.

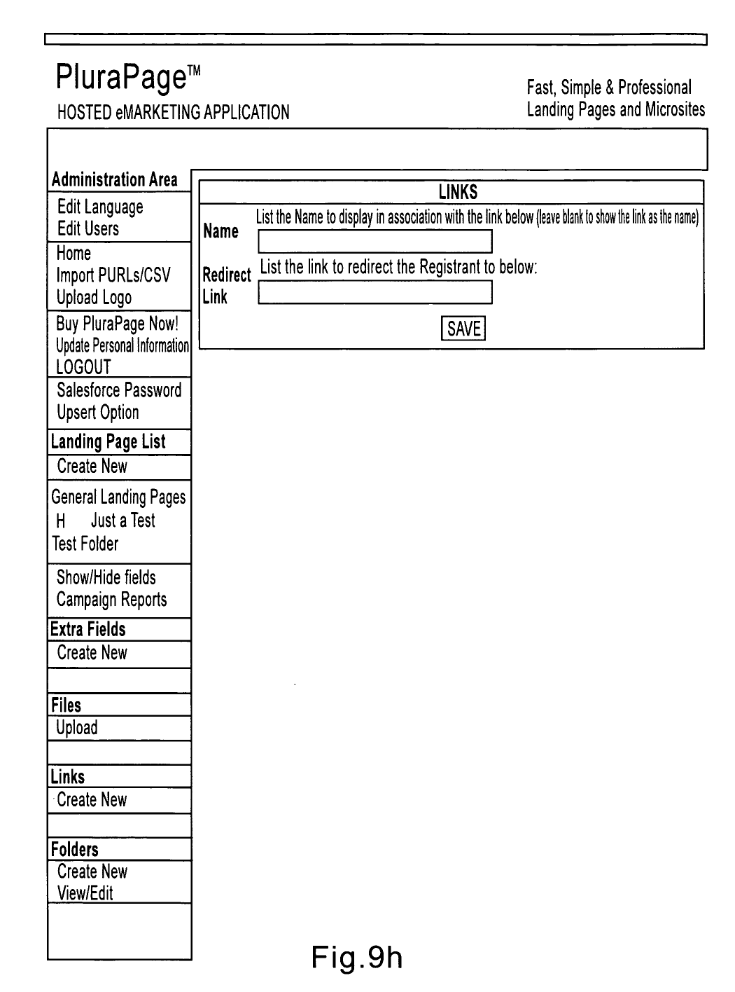

FIG. 16 is a block diagram illustrating, logically, the rendering of a PURL according to an embodiment of the present invention. Data from a CRM database is merged with a template and rendered according to the rendering process of the present invention in order to create the PURL, which is capable of submitting data back to the CRM database.

Systems, processes, and components described in this document may be implemented using one or more general purpose computers, microprocessors, or the like programmed according to the teachings of the present specification, as will be appreciated by those skilled in the relevant art(s). Appropriate software may be available that may be customized or used off-the-shelf to perform one or more aspects of the present invention. Further, aspects of the present invention can be implemented with one or more computer program modules developed by skilled programmers in readily available computer languages such as C++, PHP, HTML, XML, etc., based on the teachings of the present disclosure, as will be apparent to those skilled in the relevant art(s).

Similarly, one skilled in the art will understand that the present invention may be embodied in numerous configurations, including different computer architectures, such as centralized or distributed architectures.

One or more aspects of the present invention may includes a computer-based product, which may be hosted on a storage medium and include executable code for performing one or more steps of the invention. Such storage mediums can include, but are not limited to, computer disks including floppy or optical disks or diskettes, CDROMs, magneto-optical disks, ROMs, RAMs, EPROMs, EEPROMs, flash memory, magnetic or optical cards, or any type of media suitable for storing electronic instructions, either locally or remotely.

Subject to availability, any domain name with any ending can be used with the present invention. According to embodiments of the present invention, domains will be registered for one year with an ICANN accredited registrar.

According to an embodiment, the system utilizes PHP: Hypertext Preprocessor 5.0 (“PHP”) for dynamic page coding and MySQL for data storage, but the invention can be implemented with any computer code used for web page creation, and can use any data storage applications. All page content and user responses are stored in a database. The PHP preferably compiles the pages dynamically and renders in W3C HTML 4.01 compliant HTML, resulting in wide cross browser compatibility, but the invention can be reduced to practice using various computer coding languages and applications.

Any level of security may be applied to the present invention and its operation and use.

The present invention may be configured to be compatible with any CRM or statistical analysis package, including, but not limited to SPSS™, Salesforce.com and Microsoft Excel™. Using the data download feature found in the administrator, all data in or collected may be exported for importation into other programs.

One skilled in the art should understand that while the invention is most suitable for applications in eCommerce over the Internet, it is also applicable to intranet applications and may be implemented on private networks or the like.

Thus, a number of embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

We Claim:

1. A computer-readable medium storing computer-executable instructions for generating and rendering a landing page, by performing operations comprising:
receiving a request for a web page;
identifying rendering parameters based upon said request;
rendering a landing page dynamically, based upon said rendering parameters;
receiving submission data via said rendered landing page;
generating at least one of an email to an email account based on said submission data, a post submission web page based on said submission data, or a data file containing at least a portion of said submission data; and
storing at a least a portion of said submission data into a data storage facility.

2. The computer-readable medium according to claim 1, wherein said operation of rendering said landing page includes accessing a remote data facility and merging data stored in said remote data facility with said at least one landing page such that form fields in said landing page are pre-populated with said data, based upon said rendering parameters.

3. The computer-readable medium according to claim 2, wherein said landing page is dynamically generated via a web scripting program.

4. The computer-readable medium according to claim 2, wherein said request is an HTTP message.

5. The computer-readable medium according to claim 2, wherein said landing page is an HTML document including form fields.

6. The computer-readable medium according to claim 2, further comprising executable instructions for performing an operation of storing rendering data for defining how to render said landing page.

7. The computer-readable medium according to claim 2, further comprising executable instructions for generating and storing statistical data relating to said request.

8. The computer-readable medium according to claim 7, further comprising executable instructions for providing administrative facilities for modifying said rendering data.

9. The computer-readable medium according to claim 1, wherein said rendering parameters are stored in a data storage facility and include one or more of the following parameters:
identification of a template;
identification of content including text, graphics and form fields;
identification of a destination email address for sending a post-submission email;
identification of a file format for a post generation file to be generated including the submission data; and
identification of content to be included in a post submission.

10. The computer-readable medium according to claim 9, wherein said template is an HTML or XML document.

11. A system for generating, maintaining and rendering a landing page, comprising:
one or more processing units configured to make a user interface accessible over an electronic data network, said user interface comprising one or more forms allowing entry of rendering parameters, said rendering parameters including at least identification of a template and a plurality of form fields, said rendering parameters being stored in a data storage facility;
one or more processing units coupled with the electronic data network and configured to receive a request over said electronic data network from client device, said request including identification of an uniform resource locator, to access said data storage facility, and to dynamically render to said client device at least one landing page based upon said request and said rendering parameters, said at least one landing page to include data fields for receiving submission data; and
one or more processing units coupled with the electronic data network and configured to receive a submission of said landing page by said client device including submission data, to generate an email to an email account based on said submission data, to render a post submission web page based on said submission data, to output a data file containing at least a portion of said registration data, and to store at a least a portion of said submission data into a data storage facility.

12. The system according to claim 11, wherein said server device is further configured to access a remote data facility and to merge data stored in said remote data facility with said at least one landing page such that form fields in said landing page are pre-populated with said data.

13. The system according to claim 11, wherein said landing page is dynamically generated based upon said request.

14. The system according to claim 11, wherein said request is an HTTP message.

15. The system according to claim 11, wherein said landing page is an HTML document including form fields.

16. The system according to claim 11, further comprising data storage facilities for storing rendering data for defining how to render said landing page.

17. The system according to claim 16, wherein said data storage facilities store said one or more landing pages.

18. The system according to claim 11, wherein said server is further configured to generate and store statistical data relating to said request.

19. The system according to claim 16, further comprising administrative facilities for modifying said rendering data.

20. A method for hosting a landing page, comprising steps of:
receiving a request for at least one landing page;
rendering a landing page based upon said request;
receiving, via said rendered landing page, submission data;
generating an email to an email account based on said submission data;
rendering a post submission web page based on said submission data;
outputting a data file containing at least a portion of said submission data; and
storing at a least a portion of said submission data into a data storage facility.

21. The method according to claim 20, wherein said step of rendering said landing page includes accessing a remote data facility and merging data stored in said remote data facility with said at least one landing page such that form fields in said landing page are pre-populated with said data.

22. The method according to claim 20, wherein said landing page is dynamically generated based upon said request.

23. The method according to claim 20, wherein said request is an HTTP message.

24. The method according to claim 20, wherein said landing page is an HTML document including form fields.

25. The method according to claim 20, further a step of storing rendering data for defining how to render said landing page.

26. The method according to claim 20, further comprising a step of generating and storing statistical data relating to said request.

27. The method according to claim 25, further comprising steps of providing administrative facilities for modifying said rendering data.

28. A system for generating landing pages, comprising:
a user interface configured to allow input of an identification of a plurality of fields and rendering criteria;
a template defining a look and feel of a web page;
a landing page generating facility configure to receive an identification of a plurality of fields and rendering criteria from said user interface and to generate a landing page on said template and said rendering criteria, said landing page including said plurality of fields.

29. The system according to claim 28, further comprising:
a storage facility configured to store said rendering criteria, said template, and said landing page; and
a web server facility configured to render said landing page according to said rendering criteria.

30. The system according to claim 29, wherein said rendering criteria comprises:
identification of a destination email address; and
wherein said server facility is configured to generate an email to said destination email address upon submission of said landing page.

31. The system according to claim 29, wherein said rendering criteria comprises:
identification of a remote database and connection information for connected to the remote database;
wherein said server facility is configured to access said remote database and to generate said landing page with at least one form field being pre-populated with data from said remote database.

32. The system according to claim 31, wherein said server facility is further configured to update data in said remote database upon submission of said landing page.

33. A method for generating, maintaining and rendering a landing page, comprising:
at a client computer coupled with an electronic data network, sending a request for access to client user interface;
in response to said request, receive one or more client user interface forms configure having form fields for entry of rendering data including form fields for making a selection of at least one field to be included in a landing page, a URL for the landing page, and a template;
submitting said rendering data via said one or more form fields;
in response to said submitting step, rendering data is stored in a remote data facility;
wherein a server facility is configured to dynamically generate the landing page based upon said rendering data in response to a request for the URL of the landing page.

34. The method as recited in claim 33, wherein said rendering data includes graphics to be included in said landing page.

35. The method as recited in claim 33, wherein said rendering data includes text to be included in said landing page.

36. The method as recited in claim 33, wherein said rendering data includes an email address and said server is configured to generate an email to said email address upon submission of said landing page.

37. The method as recited in claim 33, wherein said rendering data includes text to be included in a post submission screen, and said server is configured to generated a post submission screen including said text, upon submission of said landing page.

38. The method as recited in claim 33, wherein said rendering data includes a folder name, identification of a database, and connection information for connecting to the database, and said server is configured to generated said landing page including information from said database and make said landing page available via a URL including a subdomain defined by said folder.
